(19) United States
(12) Patent Application Publication
(10) Pub. No.: US 2006/0175875 A1
(43) Pub. Date: Aug. 10, 2006

(54) Auto-lateral translation seat

(76) Inventors: Glenn F. Syrowik, Ortonville, MI (US); Peter P. Zeimis III, Shelby Township, MI (US); Carl J. Holdampf, Farmington Hills, MI (US); Ravi Hosalli, Troy, MI (US); Ronald J. Kaip, Sterling Heights, MI (US); Omar D. Tame, West Bloomfield, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/056,375

(22) Filed: Feb. 10, 2005

(51) Int. Cl. B60N 2/36; B60N 2/00; B60N 2/06

(52) U.S. Cl. 297/15; 297/331; 297/335; 297/378.1

(57) ABSTRACT

A lateral translating seat assembly and a method and system for lateral seat translation. The assembly includes a seat attached to a vehicle mount and having a seat position and a stow position. A lateral forcing element is operably attached to the vehicle mount and seat so that rotation of the seat about a horizontal axis with respect to the vehicle results in lateral translation of the seat. The method includes the steps of rotating the seat between seat position and stow position, and laterally translating the seat based on the rotation. The method further includes the step of stopping the lateral translation at one of a seat location or the stow location. The system includes means for rotating a seat between a seat position and a stow position and means for laterally translating the seat based on the rotation.

### TECHNICAL FIELD OF THE INVENTION

The present invention relates generally to folding vehicle seat assemblies. More particularly, the invention relates to an assembly method and system providing lateral translation in conjunction with a folding seat in a vehicle.

### BACKGROUND OF THE INVENTION

Conventional vehicle folding seat assemblies provide for the mechanical folding operation of a seat back between a seat position and a collapsed position. Often times it is necessary to provide at least a secondary action from a user of the vehicle in order to ready the seat assembly for stowing. For example, a user may be required to provide a force to manually translate the seat assembly inward, and a second force to put the assembly in collapsed position. A user may also or alternatively be required to detach the seat assembly from the vehicle and move it into stow position. Such seat assemblies are difficult to use and less desirable to the user.

Therefore, there exists a need in the art to provide a seat assembly that automatically aligns a seat assembly into its stow position.

### SUMMARY OF THE INVENTION

A first aspect of the present invention provides a lateral translating seat assembly for a vehicle. The assembly includes a seat attached to a vehicle mount, the seat having a seat position and a stow position. The seat assembly also includes a lateral forcing element connected between the seat and vehicle mount. The seat is laterally translated based on rotation of the seat about a horizontal axis with respect to the vehicle.

A second aspect of the invention provides a method for translating a seat in a vehicle. The method includes the steps of moving a seat between a seat position and a stow position, and laterally translating the seat based on the movement. Another aspect of the method includes stopping the lateral translation at one of the seat location or stow location.

A third aspect of the invention provides a system for translating a seat in a vehicle. The system includes means for rotating a seat between a seat position and a stow position, and means for laterally translating the seat based on the rotation.

The foregoing and other features and advantages of the invention will become further apparent from the following detailed description of the presently preferred embodiments, read in conjunction with the accompanying drawings. The drawings are not drawn to scale. The detailed description and drawings are merely illustrative of the invention, rather than limiting the scope of the invention being defined by the appended claims and equivalents thereof.

### BRIEF DESCRIPTION OF THE DRAWINGS

FIG. 1 is a view of a lateral translating seat assembly in accordance with one embodiment of the present invention;

FIGS. 2, 3, and 4 are views of a seat shown in FIG. 1 moving from a seat position to a stow position;

FIG. 5 is a schematic view illustrating alternate lateral locations of a seat shown in FIG. 1; and

FIG. 6 is a perspective view of the lateral translating seat assembly shown in FIG. 1 illustrating a stow position shown in FIG. 4 and a stow location shown in FIG. 5.

### DESCRIPTION OF THE PRESENTLY PREFERRED EMBODIMENTS

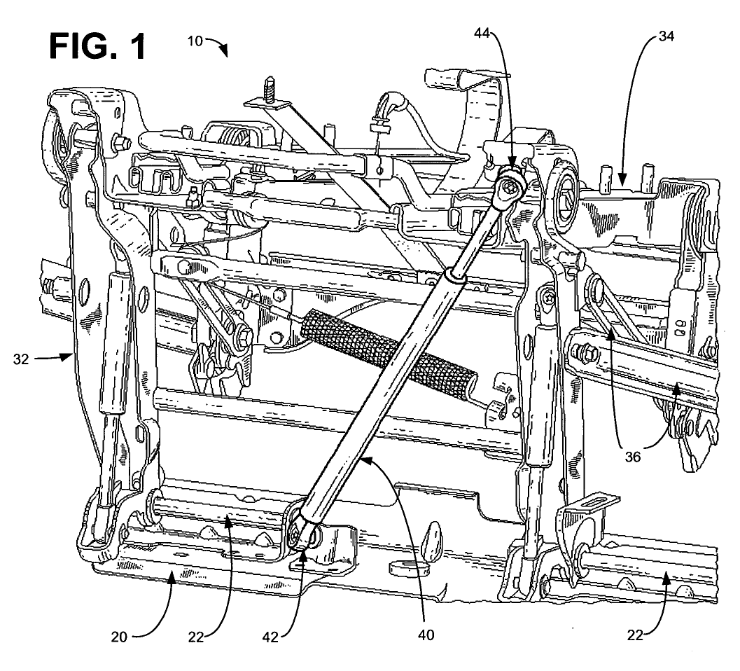

Referring to the drawings, wherein like reference numerals refer to like elements, FIGS. 1-6 are alternative views of various portions of a lateral translating seat assembly in accordance with one embodiment of the present invention. The seat assembly is shown generally by numeral 10. Assembly 10 includes a vehicle mount 20 and a seat 30. Seat 30 includes a seat base 32 rotatably attached by folding mechanism 36 to a seat back 34. Vehicle mount 20 includes translation pins 22 on which seat 30 is slidably attached, allowing the seat 30 to be laterally re-positioned with respect to vehicle mount 20. Seat 30 may be rotatably attached to vehicle mount 20. Those skilled in the art will recognize that the lateral translating seat assembly may vary and is not limited by the description and illustrations provided herein. As used herein, the term “lateral” referring to the re-positioning of seat 30 with respect to vehicle mount 20 is not limited to a strict linear side-to-side movement, but to a generalized sideways movement following an infinite number of paths therebetween, e.g. straight, simple curve or arc, compound curve, or the like. Further, while the assembly is illustrated with two translation pins 22, any number of translation pins may be employed.

A lateral forcing element 40 is attached to vehicle mount 20 and seat 30. Lateral forcing element 40 may take the form of one or more rods, gears, helixes, cables, pulleys, any combination thereof, or the like. Lateral forcing element 40 is attached to vehicle mount 20 and seat 30. Lateral forcing element 40 is attached to vehicle mount 20 by lower lateral forcing element mount 42. Lateral forcing element 40 is attached to seat 30 by upper lateral forcing element mount 44. In one embodiment, upper lateral forcing element mount 44 may be attached to seat base 32. Alternatively, upper lateral forcing element mount 44 may be attached to seat back 34, or folding mechanism 36.

The disclosed embodiments may be utilized in various types of vehicles employing lateral translating seat systems. Preferred embodiments, by way of example, are shown and described herein as an automobile vehicle employing the invention. While the preferred embodiments include an automobile-based lateral translating seat assembly, it will be appreciated by those skilled in the art that the invention is not limited to automobiles alone but may be applied to other vehicles employing lateral translating seat systems such as trucks, airplanes, boats, and the like.

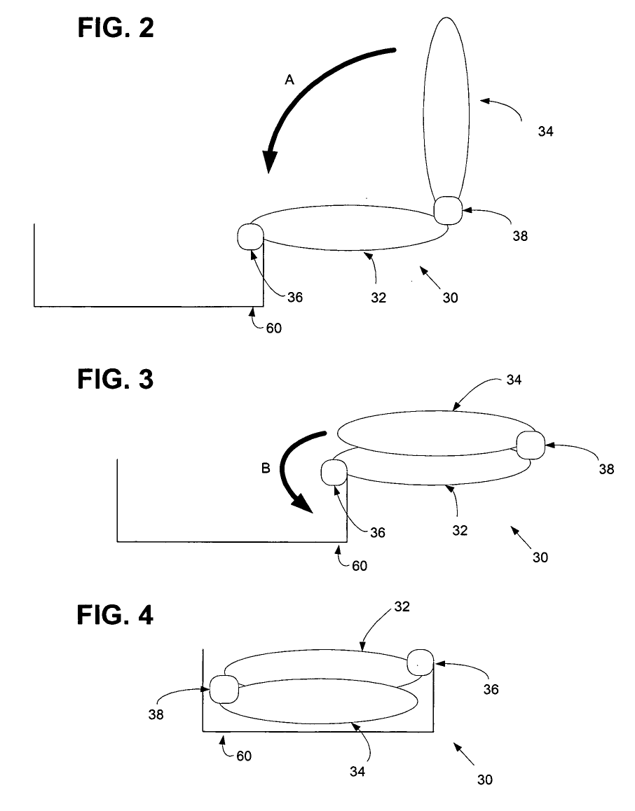

As shown in FIGS. 2, 3 and 4, seat 30 may be adjusted into multiple positions. Referring now to FIGS. 1 and 2, seat 30 is shown in a seat position. Seat back 34 is in a relatively perpendicular position with respect to seat base 32. As part of the stowing process, a vehicle user may rotate seat back 34 forward along arc A, about axis or fulcrum 38. Upper lateral forcing element mount 44 may be attached to seat back 34. When seat back 34 is rotated forward, upper lateral forcing element mount 44 moves, and a force is applied along lateral forcing element 40. In one embodiment, lateral forcing element 40 is a prop rod of fixed length with an internal spring mechanism (not shown). The prop rod 40 is attached to seat 30 and vehicle mount 20 in such a manner that rotation of the seat along a horizontal axis relative to the vehicle results in movement of upper lateral forcing element mount 44 and a force applied along prop rod 40. The movement of the upper lateral forcing element mount 44 and force applied along prop rod 40 are translated into lateral movement of seat 30. The internal spring mechanism of the prop rod 40 permits seat 30 to overtravel along translation pins 22 to ensure proper translation of seat 30 relative to seat storage bin 60. Seat 30 may then be stowed in a seat storage bin 60 located in vehicle floor.

Referring now to FIG. 1 and FIG. 3, seat 30 is shown part way through the stowing process. Seat back 34 is in a relatively parallel position with respect to seat base 32. As part of the stowing process for assembly 10 of FIG. 1, a vehicle user may rotate seat base 32 forward along arc B, about the axis or fulcrum represented by folding mechanism 36 and vehicle mount 20. Upper lateral forcing element mount 44 may be attached to seat base 32. When seat base 32 is rotated forward, upper lateral forcing element 44 moves, and a force is applied along lateral forcing element 40.

Referring now to FIG. 1 and FIG. 4, seat 30 is shown in its collapsed stow position. Seat back 34 is in a relatively parallel position with respect to seat base 32, seat base 32 is now over seat back 34, and seat 30 is in seat storage bin 60. A vehicle user may move the seat from the stow position to the seat position by rotating the seat in the opposing directions along arc B and arc A. Opposite force applied to seat 30 along arc B or arc A results in opposite lateral movement.

In one embodiment, lateral forcing element 40 may be adjustable, variable or flexible in length, and the forward or backward rotation may still result in lateral movement of seat 30. For example, lateral forcing element 40 may collapse or expand some portion of its length without resistance, prior to applying force along its length that may be translated into lateral movement of seat 30. By way of another example, lateral forcing element 40 may be spring loaded, contain a pressurized piston, or the like, allowing some portion of the rotational motion to take place before enough force is applied down its length capable of causing lateral movement of seat 30.

While FIGS. 2, 3, and 4 illustrate one embodiment of the movements of seat back 34 and seat base 32, those skilled in the art will appreciate that other embodiments are possible. For example, seat back 34 may fold in a direction opposite of arc A, bringing it to a fully extended or flat position for stowing. Alternatively, seat back 34 may not fold in respect to seat base 32 during the stowing process. In one embodiment, the vehicle user may rotate the seat along arc A and B simultaneously. Any number of configurations and movements may be used individually or in combination to collapse seat 30 and bring it to the stow position.

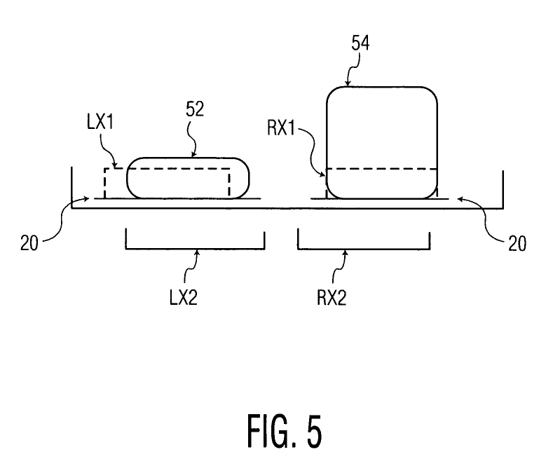

FIG. 5 provides a schematic view of a cross section of a vehicle viewed from behind, illustrating alternate example lateral locations of two seats 30, left seat 52 and right seat 54, with respect to vehicle mounts 20. In the stowed seat position, left seat 52 may sit in a location LX2 with respect to vehicle mount 20, which may be called the stowed location. In an upright seat position, right seat 54 may sit in a location RX1 with respect to vehicle mount 20, which may be called a seat location. Rotational movement of right seat 54 into a seat position along arc A and/or B may result in a lateral movement from the direction of stow location RX2 to seat location RX1. Rotational movement of left seat 52 into the stow position in the opposite direction along arc A and/or B may result in a lateral movement from the direction of seat location LX1 to stow location LX2. While this diagram illustrates inboard movement of right seat 54 as it is rotated to the stow position, this is only exemplary. Further, while a singular motion in one dimension is described, seat 30 may undergo additional movements, for example upward or downward, during the stowing process. The lateral movement is described in isolation, but those skilled in the art will appreciate that combinations of appropriate upper and lower rod mounts 42, 44, translation pin 22, vehicle mount 20 and seat 30 may be employed to allow an infinite number of combined movements.

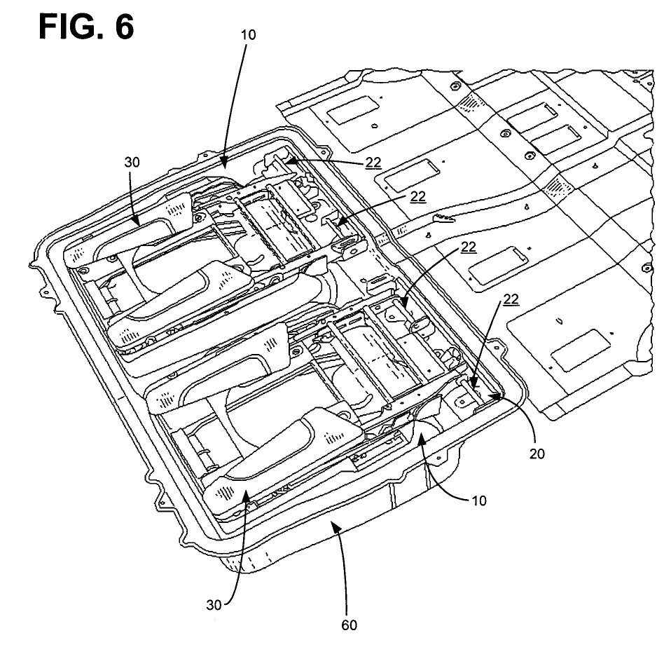

FIG. 6 illustrates a perspective view of lateral translating seat assembly 10 in the stow position. Seat 30 has moved inboard along translation pin 22 to align with its stow location. Where seat 30 is rotated upright to the seat position, seat 30 is brought outward to the seat location. Also illustrated is seat storage bin 60. Lateral translation of seat 30 is performed over a predetermined distance. This predetermined distance aligns seat 30 with seat storage bin 60. Once seat 30 is aligned with seat storage bin 60 it may be collapsed into seat storage bin 60.

In one embodiment, the rotation of seat 30 may be performed by a vehicle user. Alternatively, the rotation may be motorized. While the invention has been described with the rotational motion causing the lateral movement, it should be understood that the same assembly and system may provide the rotational movement based on lateral motion. Therefore, a vehicle user or motorized operation that slides seat 30 along translation pin 22 may be translated into rotational movement of the seat 30.

While the embodiments of the invention disclosed herein are presently considered to be preferred, various changes and modifications can be made without departing from the spirit and scope of the invention. The lateral translating seat assembly, method, and system are not limited to any particular design or arrangement. For example, the seat, vehicle mount, translation pin, lateral forcing element, and lateral forcing element mounts, and the materials thereof may vary without limiting the utility of the invention.

Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

1. A lateral translating seat assembly for a vehicle, comprising:
a seat slidably and rotatably attached to a vehicle mount, the seat having a seat position and a stow position; and
a lateral forcing element connected between the seat and the vehicle mount wherein rotation of the seat about a horizontal axis with respect to the vehicle laterally translates the seat.

2. The assembly of claim 1, wherein the lateral forcing element is a prop rod attached at a first end to the vehicle mount and at a second end to the seat.

3. The assembly of claim 2, wherein the prop rod has a fixed length.

4. The assembly of claim 1, wherein the seat is slidably attached to a translation pin of the vehicle mount.

5. The assembly of claim 1, wherein the rotation of the seat is a rotation of the seat between the seat position and the stow position.

6. The assembly of claim 1, wherein the seat has two or more parts rotatably connected.

7. The assembly of claim 6, wherein the motion of the seat is a rotation of one part of the seat with respect to a second part of the seat.

8. The assembly of claim 1 wherein the motion of the seat to the stow position is translated into an inward lateral force via the lateral forcing element to move the seat inward.

9. The assembly of claim 1 wherein the rotation of the seat to seat position is translated into an outward lateral force via the lateral forcing element to move the seat outward.

10. The assembly of claim 1 wherein the seat is slid a predetermined distance to align the seat with a seat storage bin of the vehicle.

11. A method for translating a seat in a vehicle, the method comprising:
moving a seat between a seat position and a stow position; and
laterally translating the seat based on the movement.

12. The method of claim 11, wherein the movement is a rotational movement.

13. The method of claim 11, wherein the seat is translated inward when the seat is moved to the stow position.

14. The method of claim 11, wherein the seat is translated outward when the seat is moved to a seat position.

15. The method of claim 11, further comprising stopping the lateral translation at one of a seat location or a stow location.

16. A system for translating a seat in a vehicle, the system comprising:
means for rotating a seat between a seat position and a stow position; and
means for laterally translating the seat based on the rotation.
